(19) United States
(12) Patent Application Publication
(10) Pub. No.: US 2023/0421444 A1
(43) Pub. Date: Dec. 28, 2023

(54) SYSTEM AND METHOD FOR OVER THE AIR COMMISSIONING OF DEVICES COMMUNICATING OVER A COMMUNICATION NETWORK

(71) Applicant: SPINTLY INC, Milpitas, CA (US)

(72) Inventors: Malcolm DSOUZA, Margao (IN); Marc MIRANDA, Panaji (IN); Aniket SHET, Bicholim (IN); Rohin PARKAR, Ponda (IN); Dominic BARRETTO, Sangolda (IN)

(21) Appl. No.: 18/037,849

(22) PCT Filed: Nov. 19, 2021
(86) PCT No.: PCT/IN2021/051082

§ 371 Date: May 19, 2023

(30) Foreign Application Priority Data
Nov. 19, 2020 (IN) 202021038165

(51) Int. Cl. H04L 41/08; H04W 60/04; H04W 8/18; H04W 8/22; H04L 41/0806; H04W 12/06

(52) U.S. Cl. CPC H04L 41/0886; H04W 60/04; H04W 8/186; H04W 8/22; H04L 41/0806; H04W 12/068; H04W 84/18

(57) ABSTRACT

Disclose is a system (100) for over the air commissioning, the system (100) including: a plurality of devices (102) coupled to one another by way of a communication network (108), wherein a first device (102a) of the plurality of devices (102) is configured to generate and provide a request signal to a second device (102b) of the plurality of devices (102), a server (106) that is coupled to the plurality of devices (102), and configured to: receive the request signal from the second device (102b); register, based on the request signal, the first device (102a) as a non-commissioned device; and transmit, in response to the request signal, network credentials to the second device (102b), wherein the first device (102a) is commissioned over the air with the communication network (108) based on the network credentials by way of the second device (102b).

### TECHNICAL FIELD

The present invention relates to a field of commissioning of devices in a wireless network. more particularly, the present invention relates to a system and a method for over the air commissioning of devices communicating over a communication network.

### BACKGROUND

A wireless network (e.g., an internet of things (IOT) network) can include various types of devices like light bulbs, light panels, temperature and humidity sensors, access control readers, range extenders, gateway etc. In order to talk to such devices, such devices need to be on-boarded in the IoT network in a secure manner. This involves first authenticating the device and second passing network credentials and configurations to the device over encrypted link.

In existing wireless mesh networks once, the devices are deployed in field they are required to be commissioned in the wireless mesh networks. The commissioning process is done using smart phone, tablet, and computer and the like which requires a person to be present physically near the devices. The requirement of a person increases the overall cost of the solution as there is always a requirement of manpower at the site where devices are deployed.

Thus, there is a need for a technical solution that overcomes the aforementioned problems of conventional commissioning systems and methods.

### SUMMARY

One aspect of the present disclosure provides a system for over the air commissioning, the system including a plurality of devices coupled to one another by way of a communication network. A first device of the plurality of devices is configured to generate and provide a request signal to a second device of the plurality of devices. The system further includes a server that is coupled to the plurality of devices, and configured to receive the request signal from the second device. The server is further configured to register, based on the request signal, the first device as a non-commissioned device. The server is further configured to transmit, in response to the request signal, network credentials to the second device. The first device is commissioned over the air with the communication network based on the network credentials by way of the second device.

In some aspects of the present disclosure, the request signal includes a unique identifier (ID) associated with the first device such that the unique ID facilitate to identify one of, a location of the first device, a type of the first device, a communication network to which the first device is to be tagged to.

In some aspects of the present disclosure, the second device is a commissioned device with the communication network.

In some aspects of the present disclosure, the system further includes a processing circuitry that is coupled to the plurality of devices, and configured to receive, from the second device, the request signal over the communication network.

In some aspects of the present disclosure, the processing circuitry is further configured to transmit the request signal to the server.

In some aspects of the present disclosure, the processing circuitry is further configured to receive, in response to the request signal, the network credentials assigned to the first device adapted to commission the first device from the server. In some aspects of the present disclosure, the processing circuitry is further configured to provide the network credentials to the second device such that the second device commissions the first device with the communication network based on the network credentials.

In some aspects of the present disclosure, the communication network includes one of, an Internet of Things (IOT) network, a Bluetooth Low Energy (BLE) network, a Zigbee network, or a combination thereof.

In some aspects of the present disclosure, the plurality of devices includes one of, IOT light bulbs, IOT light panels, IOT temperature sensors, IOT humidity sensors, IOT access control readers, IOT range extenders, or a combination thereof.

In some aspects of the present disclosure, prior to receiving the request signal from the second device, the processing circuitry is configured to receive network credentials assigned by the server, and wherein the processing circuitry is commissioned with the communication network based on the network credentials. In some aspects of the present disclosure, each device of the plurality of devices is configured to transmit to a first group address, and wherein the processing circuitry is configured to transmit to a second group address.

In some aspects of the present disclosure, the processing circuitry is configured to be subscribed to the first group address, and wherein each device of the plurality of devices is configured to be subscribed to the second group address.

In some aspects of the present disclosure, the server further includes a database that is configured to store the first device in a list of non-commissioned devices with the associated unique ID of the first device.

In some aspects of the present disclosure, the database is further configured to store a list of commissioned devices and associated unique IDs of the commissioned devices.

Another aspect of the present disclosure provides a method for over the air commissioning of the first device of the plurality of devices, the method including steps of: generating by way of a first device of a plurality of devices a request signal, wherein the request signal is provided to a second device of a plurality of devices; receive, by way of the processing circuit of the system, the request signal from the second device; providing, by way of the processing circuit, the request signal to a server of the system; registering and storing, by the server, in response to the request signal the first access device along with a unique identifier (ID) associated with the first access device as a non-commissioned device in a list of non-commissioned devices within a database of the server; transmitting, in response to the request signal, network credentials assigned by the server to the second device; and commissioning, by way of the second device, based on the network credentials, the first device over the air with a communication network.

### BRIEF DESCRIPTION OF THE DRAWINGS

Other objects, features, and advantages of the embodiment will be apparent from the following description when read with reference to the accompanying drawings.

In the drawings, wherein like reference numerals denote corresponding parts throughout the several views:

The diagrams are for illustration only, which thus is not a limitation of the present disclosure, and wherein:

FIG. 1A illustrates a block diagram of a system for over the air commissioning, in accordance with an aspect of the present disclosure;

FIG. 1B illustrates an exemplary scenario for commissioning a first device by way of a processing circuitry via a second device and/or commissioning the first device and the second device directly by way of the processing circuitry, in accordance with an aspect of the present disclosure; and

FIG. 2 illustrates a flowchart of a method for commissioning A non-commissioned device with a communication network, in accordance with an exemplary aspect of the present disclosure.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The embodiments are in such

detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. Various terms as used herein are shown below. To the extent a term used in a claim is not defined below, it should be given the broadest definition persons in the pertinent art have given that term as reflected in printed publications and issued patents at the time of filing.

### Definitions

Over the air or OTA is used as various methods of distributing new software, configuration settings, and updating encryption keys to devices including but not limited to mobile phones, set-top boxes, electric cars and secure voice communication equipment.

The term “OTA” and “Over the air” and such other term defines over the air and are interchangeably used across the context.

“Bluetooth low energy” (BLE) is a wireless personal area network that consumes less energy than bluetooth and possess larger area than bluetooth. Beacon is a hardware transmitter, which transmits BLE signal on its proximity.

The term “Bluetooth low energy” and “BLE” and such other term defines Bluetooth low energy and interchangeably used across the context.

“Gateway” is a software, or a hardware used in telecommunications for computer networks that allows data to flow from one discrete network to another. Gateway controls the flow of data packets across the network.

The term “gateway”, “hub” and “processing circuitry” and other such term defines gateway and interchangeably used across the context.

“Data packets” is a unit of data made into a single package that travels along a given network path. Data packets are used in Internet Protocol (IP) transmissions for data that navigates the Web, and in other kinds of networks.

“Cloud” refers to servers that are accessed over the internet, and the software and databases that run on said servers. The cloud enables users to access the same files and applications from any device due to the computing and storage occurs on the servers in a data centre, instead of locally on the user device.

The term “cloud” may be used “central database” and other such term defines cloud and interchangeably used across the context.

As mentioned above, there remains a need for a Bluetooth Low Energy (BLE) mesh topology (a subset of a wireless mesh topology) that enables multiple devices to pass messages/information wirelessly between each other thus eradicating the need for wires running between multiple readers. Therefore, the present BLE technology allows for utilizing BLE to communicate through a mesh network for communicating automation protocols through a mesh network and/or to secure a mesh network from unauthorized access.

The present system provides an access control network commissioning and configuration where cloud maintains a commissioner which detects and commissions the non-commissioned nodes tagged to a particular predefined network. Wireless mesh network such as a wireless mesh network helps in commissioning the nodes which are not in direct range of gateway. Non-commissioned nodes transmit special BLE beacon to let other nodes detect it. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The terms gateway and the controller and other such term meant the same and are used interchangeably in the context.

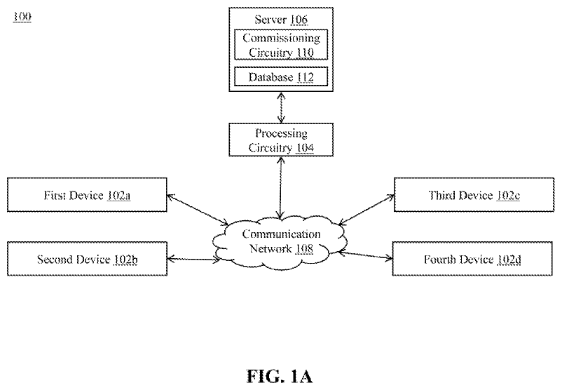

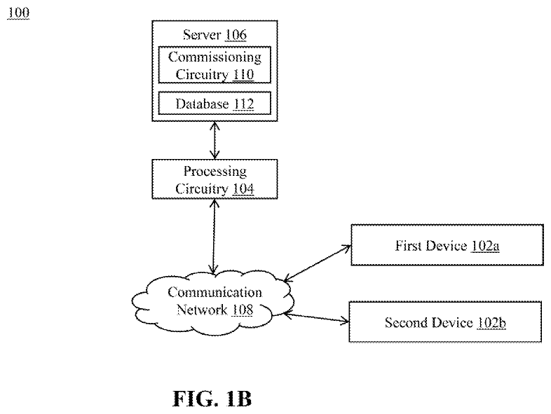

FIG. 1A illustrates a block diagram of a system 100, in accordance with an aspect of the present disclosure. The system 100 may facilitate in over the air (OTA) commissioning of a plurality of devices communicating over a mesh network. Not all of the depicted components may be used, however, one or more implementations may include additional components not shown in the figure. Variations in the arrangement and types of the components may be made without departing from the spirit or scope of the claims as set forth herein. Additional, fewer, and/or different components may be provided. The system 100 may include a plurality of devices 102 of which first through fourth devices 102a-102d are shown, processing circuitry 104, and a server 106. In the illustrated aspect of FIG. 1, the first through fourth devices 102a-102d, the processing circuitry 104, and the server 106 are communicatively coupled to each other via a plurality of communication networks of which a communication network 108 is shown. In other aspects, the first through fourth devices 102a-102d, the processing circuitry 104, and the server 106 can be communicably coupled through separate communication networks established therebetween. The system 100 including the first through fourth devices 102a-102d, the processing circuitry 104, and the server 106 that are communicatively coupled to each other via the communication network 108 to define a physical access control network.

The first through fourth devices 102a-102d may be deployed at various locations of a facility such as, but not limited to, a building, a warehouse, and the like. Aspects of the present disclosure are intended to include or otherwise cover any type of the facility. Further, the first through fourth devices 102a-102d may be internet enabled devices that may be configured to communicate with one another and/or the processing circuitry 104 over the communication network 108. In an aspect of the present disclosure, the first through fourth devices 102a-102d may be coupled to one another by way of the communication network 108. The first through fourth devices 102a-102d may form a mesh group where messages from the processing circuitry 104 may be broadcasted to nearby devices of the plurality of devices 102 and then in turn forwarded to further nearby devices of the plurality of devices 102. Such a configuration enables a limitless extension of range of operation given that there are devices of the plurality of access devices 102 within a 50 meters range of each other. Additionally, such a configuration facilitates to dramatically save wiring and routing involved during installation of the system 100.

The first through fourth devices 102a-102d may include, but is not limited to, internet of things (IOT) light bulbs, IOT light panels, IOT temperature sensors, IOT humidity sensors, IOT access control readers, IOT range extenders, and the like. It will be apparent to a person skilled in the art that the first through fourth devices 102a-102d can include any type of the internet enabled device, including known, related and later developed technologies, without deviating from the scope of the present disclosure.

The first through fourth devices 102a-102d may include suitable logic, instructions, circuitry, interfaces, and/or codes for executing various operations. For example, the first through fourth devices 102a-102d may be configured to transmit (i.e., publish) to a first group address. In other words, the first through fourth devices 102a-102d may be configured to transmit (i.e., publish) one or more data packets to one or more components of the system 100 having the first group address. Further, the first through fourth devices 102a-102d may be configured to be commissioned (i.e., registered with the communication network 108) by way of network credentials provided by the server 106.

In an example, as illustrated in FIG. 1A, the first device 102a may be a non-commissioned device such that the first device 102a is not commissioned (i.e., registered) with the communication network 108. The second through fourth devices 102b-102d may be commissioned devices such that the second through fourth devices 102b-102d are already commissioned (i.e., registered) with the communication network 108. In such scenario, the first device 102a may be configured to generate a request signal. In an aspect of the present disclosure, when the communication network 108 is a Bluetooth Low Energy (BLE) mesh network, the request signal may indicate a custom BLE beacon advertised by the first device 102a periodically. In another aspect of the present disclosure, when the communication network 108 is a thread network, the first device 102a may be configured to scan within a predefined range to identify one or more commissioned devices (i.e., the second through fourth devices 102b-102d) by sending the request signal to each device of the plurality of devices periodically. In the case where the first device 102a (i.e., a non-commissioned device) is not in direct wireless range of the processing circuitry 104, the processing circuitry 104 may not be able to commission the first device 102a. Thus, the first device 102a may be commissioned by way of the second device 102b considering that the second device 102b is in direct wireless range of the processing circuitry 104. The request signal may include a unique identifier (ID) associated with the first device 102a that may facilitate the second device 102b and the server 106 to identify one of, a location of the first device 102a, a type of the first device 102a, and a communication network (e.g., the communication network 108) of the plurality of communication networks to which the first device 102a is to be tagged to. The first device 102a may be further configured to publish (i.e., transmit) the request signal to the second device 102b that is in a wireless range of the first device 102a. For the sake of the ongoing discussion, it is assumed that the first device 102a transmits the request signal to the second device 102b, however, in other aspects of the present disclosure, the first device 102a can transmit the request signal to any one of the second through fourth device 102b-102d which is within the wireless range of the first device 102a, without deviating from the scope of the present disclosure.

The processing circuitry 104 may include suitable logic, instructions, circuitry, interfaces, and/or codes for executing various operations. For example, the processing circuitry 104 may be coupled to the first through fourth devices 102a-102d. Further, the processing circuitry 104 may be configured to receive, from the second device 102b, the request signal over the communication network 108. In other words, the processing circuitry 104 may be configured to receive the request signal associated with the first device 102a via the second device 102b.

In one aspect of the present disclosure, prior to receiving the request signal from the second device 102b, the processing circuitry 104 may be configured to receive network credentials from the server 106. The network credentials may include one of, a network key and an address associated with a communication network (e.g., the communication network 108) of the plurality of communication networks. The processing circuitry 104 may be configured to utilize the network credentials to commission (i.e., register) with the communication network 108. For the sake of the ongoing discussion, it is assumed that the network credentials are associated with the communication network 108, however, the network credentials received by the processing circuitry 104 can be associated with any of the communication network of the plurality of communication networks to which the processing circuitry 105 is to be commissioned (i.e., registered) with, without deviating from the scope of the present disclosure. In an aspect of the present disclosure, the processing circuitry 104 may be configured to transmit (i.e., publish) to a second group address. In other words, the processing circuitry 104 may be configured to transmit (i.e., publish) one or more data packets to one or more components of the system 100 having the second group address. In an aspect, the processing circuitry 104 may be configured to be subscribed to the first group address such that the first through fourth devices 102a-102d transmits (i.e., publishes) one or more data packets to the processing circuitry 104. Similarly, the first through fourth devices 102a-102d may be configured to be subscribed to the second group address such that the processing circuitry 104 transmits (i.e., publishes) one or more data packets to the first through fourth devices 102a-102d.

The processing circuitry 104 may be further configured to transmit the request signal to the server 106. The server 106 may be a network of computers, a software framework, or a combination thereof, that may provide a generalized approach to create the server implementation. Examples of the server 106 may include, but are not limited to, personal computers, laptops, mini-computers, mainframe computers, any non-transient and tangible machine that can execute a machine-readable code, cloud-based servers, distributed server networks, or a network of computer systems. The server 106 may be realized through various web-based technologies such as, but not limited to, a Java web-framework, a .NET framework, a personal home page (PHP) framework, or any web-application framework. The server 106 may be maintained by an access grant management authority or a third-party entity that facilitates granting access and commissioning of the plurality of devices 102 with the system 100. The server 106 may include commissioning circuitry 110 and a database 112.

The commissioning circuitry 110 may include suitable logic, instructions, circuitry, interfaces, and/or codes for executing various operations. For example, the commissioning circuitry 110 may be configured to receive the request signal from the processing circuitry 104. Further, the commissioning circuitry 110 may be configured to register the first device 102a as a non-commissioned device in the database 112 based on the request signal. In other words, the commissioning circuitry 110 may be configured register the first device 102a as a non-commissioned device in the database 112 such that the database 112 stores a list of non-commissioned devices and associated unique IDs of the non-commissioned devices (e.g., the first device 102a and the unique ID of the first device 102a). The unique ID of the non-commissioned devices may facilitate the commissioning circuitry 110 to identify a communication network (e.g., the communication network 108 for the first device 102a) to which the non-commissioned devices is to be tagged to. Further, in response to the request signal, the commissioning circuitry 110 may be configured to assign and transmit the assigned network credentials to the processing circuitry 104. The network credentials may be adapted to commission the first device 102a. Further, the first device 102a may be commissioned (i.e., registered) over the air with the communication network 108 based on the network credentials.

The database 112 may be configured to store the logic, instructions, circuitry, interfaces, and/or codes of the commissioning circuitry 110 for executing various operations. Further, the database 112 may be configured for storage and retrieval of data associated with the system 100. The database 112 may be further configured to store therein, the list of non-commissioned devices and associated unique IDs of the non-commissioned devices (e.g., the first device 102a and the unique ID of the first device 102a) and a list of commissioned devices and associated unique IDs of the commissioned devices (e.g., the second through fourth devices 102b-102d and the unique ID of the second through fourth devices 102b-102d). Examples of the database 112 may include but are not limited to, a centralized database, a distributed database, a relational database, a NoSQL database, a cloud database, an object-oriented database, a hierarchical database, a network database, and the like. In some aspects of the present disclosure, a set of centralized or distributed network of peripheral memory devices may be interfaced with the server 106, as an example, on a cloud server. Aspects of the present disclosure are intended to include or otherwise cover any type of the database 112 including known, related art, and/or later developed technologies.

Further, upon receiving the network credentials from the server 106, the processing circuitry 104 may be configured to provide the network credentials to the second device 102d. The network credentials may enable the second device 102b to commission (i.e., register) the first device 102a with the communication network 108. For the sake of the ongoing discussion, it is assumed that the processing circuitry 104 provides the network credentials to the second device 102b. However, the processing circuitry 104 can provide the network credentials to any of the commissioned devices (e.g., the second through fourth devices 102b-102d) which is in a wireless range of the processing circuitry 104 to commission the first device 102a with the communication network 108.

The communication network 108 may include suitable logic, circuitry, and interfaces that may be configured to provide a plurality of network ports and a plurality of communication channels for transmission and reception of data related to operations of various entities (such as the first through fourth devices 102a-102d, the processing circuitry 104, and the server 106) of the system 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 108 may be associated with an application layer for implementation of communication protocols based on one or more communication requests from the first through fourth devices 102a-102d, the processing circuitry 104, and the server 106. Communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof. In a preferred aspect of the present disclosure, the communication network 108 may include one of, an Internet of Things (IOT) network, a Bluetooth Low Energy (BLE) network, and a ZIGBEE network, and the like. Aspects of the present disclosure are intended to include or otherwise cover any type of communication channels, including known, related art, and/or later developed technologies. In one aspect, the communication data may be transmitted or received via at least one communication channel of a plurality of communication channels in the communication network 108. The communication channels may include a wireless channel. The wireless channel may be associated with a data standard which may be defined by one of a Wireless Local Area Network (WLAN), a Wireless Sensor Network (WSN), Wireless Area Network (WAN), Wireless Wide Area Network (WWAN), the Internet, an infrared (IR) network, a radio frequency (RF) network, and a combination thereof.

FIG. 1B illustrates an exemplary scenario for commissioning the first device 102a by way of the processing circuitry 104 via the second device 102b and/or commissioning the first device 102a and the second device 102b directly by way of the processing circuitry 104, in accordance with an aspect of the present disclosure. As discussed in conjunction with FIG. 1A, when the processing circuitry 104 is not in the wireless range of the first device 102a, however, the second device 102b is in the wireless range of both the first device 102a and the processing circuitry 104, the first device 102a may be configured to generate and provide the request signal to the second device 102b. In an aspect of the present disclosure, the first device 102a i.e., the non-commissioned device may be configured to automatically detect a commissioned device (e.g., the second through fourth devices 102ab-102d) in a wireless range. Further, the first device 102a may transmit (i.e., publish and/or advertise) data packets via the request signal (e.g., the BLE signal from a custom BLE beacon, and scan signal). The data packets may be transmitted on periodical basis after a predefined time interval on one or more channels. The predefined time interval between transmission of data packets may be a fixed interval and/or a random delay. Further, the processing circuitry 104 may be configured to receive the request signal from the second device 102b and may further provide the request signal to the server 106. In an aspect of the present disclosure, the server 106, in response to the request signal may register and store the first access device 102a along with the unique ID associated with the first access device 102a as a non-commissioned device in the list of non-commissioned devices in the database 112. Further, the server 106, in response to the request signal may assign and transmit the network credentials assigned to the first device 102a to the second device 102b via the processing circuitry 104. The second device 102b may be further configured to commission the first device 102a over the air with the communication network 108 based on the network credentials.

In another aspect of the present disclosure, when the processing circuitry 104 is in the wireless range of the first device 102a and the second device 102b, the first device 102a and the second device 102b may be commissioned directly by way of the processing circuitry 104. In such scenario, the first and second devices 102a and 102b may be configured to generate and provide the request signal to the processing circuitry 104. Further, the processing circuitry 104 may be configured to receive the request signal and further provide the request signal to the server 106. The server 106, in response to the request signal may register and store the first access device 102a and the second access device 102b along with the unique ID associated with the first access device 102a and the second access device 102b as a non-commissioned device in the list of non-commissioned devices in the database 112. Further, the server 106, in response to the request signal may transmit the network credentials assigned to the first device 102a and the second device 102b to the processing circuitry 104 such that the processing circuitry 104 commissions the first and second devices 102a and 102b over the air with the communication network 108 based on the network credentials.

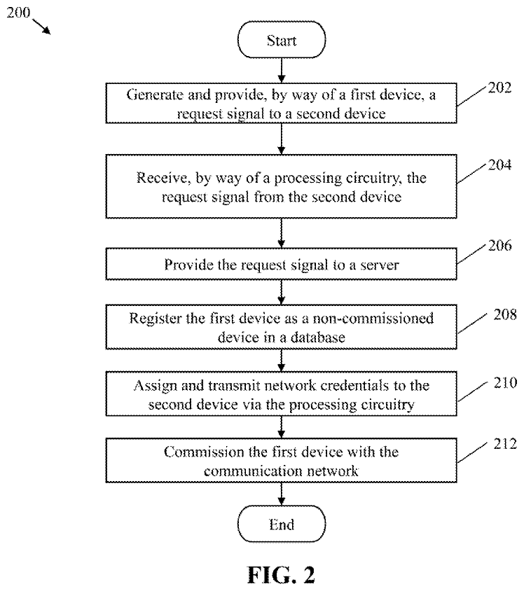

FIG. 2 illustrates a flowchart of a method 200 for commissioning the non-commissioned device (i.e., the first device 102a) with the communication network 108, in accordance with an exemplary aspect of the present disclosure.

At step 202, the first device 102a of the system 100 may generate and provide the request signal to the second device 102b of the system 100.

At step 204, the processing circuitry 104 of the system 100 may receive the request signal from the second device 102b.

At step 206, the processing circuitry 104 may provide the request signal to the server 106 of the system 100.

At step 208, the server 106, in response to the request signal may register and store the first access device 102a along with the unique ID associated with the first access device 102a as a non-commissioned device in the list of non-commissioned devices within the database 112.

At step 210, the server 106, in response to the request signal may assign and transmit the network credentials to the second device 102b via the processing circuitry 104.

At step 212, the second device 102b may commission the first device 102a over the air with the communication network 108 based on the network credentials.

As will be readily apparent to those skilled in the art, the present embodiment may easily be produced in other specific forms without departing from its essential characteristics. The present aspects are therefore, to be considered as merely illustrative and not restrictive, the scope being indicated by the claims rather than the foregoing description, and all changes which come within therefore intended to be embraced therein.

We claim:

1. A system (100) for over the air commissioning, the system (100) comprising:
a plurality of devices (102) coupled to one another by way of a communication network (108), wherein a first device (102a) of the plurality of devices (102) is configured to generate and provide a request signal to a second device (102b) of the plurality of devices (102),
a server (106) that is coupled to the plurality of devices (102), and configured to:
receive the request signal from the second device (102b);
register, based on the request signal, the first device (102a) as a non-commissioned device; and
transmit, in response to the request signal, network credentials to the second device (102b), wherein the first device (102a) is commissioned over the air with the communication network (108) based on the network credentials by way of the second device (102b).

2. The system (100) as claimed in claim 1, wherein the request signal comprises a unique identifier (ID) associated with the first device (102a) such that the unique ID facilitate to identify one of, a location of the first device (102a), a type of the first device (102a), a communication network to which the first device (102a) is to be tagged to.

3. The system (100) as claimed in claim 1, wherein the second device (102b) is a commissioned device with the communication network (108).

4. The system (100) as claimed in claim 1, further comprising a processing circuitry (104) that is coupled to the plurality of devices (102), and configured to receive, from the second device (102b), the request signal over the communication network (108).

5. The system (100) as claimed in claim 4, wherein the processing circuitry (104) is further configured to transmit the request signal to the server (106).

6. The system (100) as claimed in claim 4, wherein the processing circuitry (104) is further configured to receive, in response to the request signal, the network credentials assigned to the first device (102a) adapted to commission the first device (102a) from the server (106).

7. The system (100) as claimed in claim 4, wherein the processing circuitry (104) is further configured to provide the network credentials to the second device (102b) such that the second device (102b) commissions the first device (102a) with the communication network (108) based on the network credentials.

8. The system (100) as claimed in claim 1, wherein the communication network (108) comprises one of, an Internet of Things (IOT) network, a Bluetooth Low Energy (BLE) network, a Zigbee network, or a combination thereof.

9. The system (100) as claimed in claim 1, wherein the plurality of devices (102) comprises one of, IOT light bulbs, IOT light panels, IOT temperature sensors, IOT humidity sensors, IOT access control readers, IOT range extenders, or a combination thereof.

10. The system (100) as claimed in claim 4, wherein, prior to receiving the request signal from the second device (102b), the processing circuitry (104) is configured to receive network credentials assigned by the server (106), and wherein the processing circuitry (104) is commissioned with the communication network (108) based on the network credentials.

11. The system (100) as claimed in claim 1, wherein each device of the plurality of devices (102) is configured to transmit to a first group address, and wherein the processing circuitry (104) is configured to transmit to a second group address.

12. The system (100) as claimed in claim 1, wherein the processing circuitry (104) is configured to be subscribed to the first group address, and wherein each device of the plurality of devices (102) is configured to be subscribed to the second group address.

13. The system (100) as claimed in claim 1, wherein the server (106) further comprises a database (112) that is configured to store the first device (102a) in a list of non-commissioned devices with the associated unique ID of the first device (102a).

14. The system (100) as claimed in claim 13, wherein the database (112) is further configured to store a list of commissioned devices and associated unique IDs of the commissioned devices.

15. A method (200) for over the air commissioning of the first device (102a) of the plurality of devices (102), the method comprising steps of:
generating by way of a first device (102a) of a plurality of devices (102) a request signal, wherein the request signal is provided to a second device (102b) of a plurality of devices (102);
receive, by way of the processing circuit (104) of the system (100), the request signal from the second device (102b);
providing, by way of the processing circuit (104), the request signal to a server (106) of the system (100);
registering and storing, by the server (106), in response to the request signal the first access device (102a) along with a unique identifier (ID) associated with the first access device (102a) as a non-commissioned device in a list of non-commissioned devices within a database (112) of the server (106);
transmitting, in response to the request signal, network credentials assigned by the server (106) to the second device (102b); and
commissioning, by way of the second device (102), based on the network credentials, the first device (102a) over the air with a communication network (108).

16. The method (200) as claimed in claim 15, wherein the request signal comprises a unique identifier (ID) associated with the first device (102a) such that the unique ID facilitate to identify one of, a location of the first device (102a), a type of the first device (102a), a communication network to which the first device (102a) is to be tagged to.

17. The method (200) as claimed in claim 15, further comprising a step of storing, by way of the server (106), a list of commissioned devices and associated unique IDs of the commissioned devices in the database (112).

18. The method (200) as claimed in claim 15, wherein the communication network (108) comprises one of, an Internet of Things (IOT) network, a Bluetooth Low Energy (BLE) network, a Zigbee network, or a combination thereof.

19. The method (200) as claimed in claim 15, wherein the plurality of devices (102) comprises one of, IOT light bulbs, IOT light panels, IOT temperature sensors, IOT humidity sensors, IOT access control readers, IOT range extenders, or a combination thereof.

20. The method (200) as claimed in claim 15, wherein the second device (102b) is a commissioned device with the communication network (108).
